(19) United States
(12) Patent Application Publication
(10) Pub. No.: US 2004/0196883 A1
(43) Pub. Date: Oct. 7, 2004

(54) Diode-pumped solid state laser system utilizing high power diode bars

(75) Inventor: Harry Rieger, San Diego, CA (US)

Correspondence Address: BAKER & MCKENZIE, PATENT DEPARTMENT, 2001 ROSS AVENUE, SUITE 2300, DALLAS, TX, 75201, US

(73) Assignee: JMAR Research Inc.

(21) Appl. No.: 10/816,728

(22) Filed: Apr. 2, 2004

Related U.S. Application Data
(60) Provisional application No. 60/460,315, filed on Apr. 3, 2003.

(51) Int. Cl. H01S 3/091; H01S 3/092; H01S 3/094

(52) U.S. Cl. 372/75

(57) ABSTRACT

Disclosed herein is a diode-pumped solid state (DPSS) laser having a laser rod and a diode array, located proximate the laser rod. In one embodiment, the diode array includes a plurality of high power diode bars spaced along the diode array, where each is configured to emit radiation therefrom. In addition, in this embodiment, the spacing of the high power diode bars and the location of the diode array with respect to the laser rod are selected to allow the laser rod to receive the radiation from the high power diode bars in a substantially uniform distribution. In addition, a method of manufacturing a DPSS laser, and a DPSS laser assembly are also disclosed.

### RELATED APPLICATIONS

This application claims priority to U.S. provisional patent application No. 60/460,315 entitled “Diode-Pumped Solid State Laser System Utilizing High Power Diode Bars,” which was filed with the Patent Office on Apr. 3, 2003 and is hereby incorporated by reference into this patent application.

### FIELD OF THE INVENTION

The present invention relates, in general, to diode-pumped solid state (DPSS) lasers, and, more specifically, to a DPSS laser having a diode array with high power diode bars where a spacing of the diode bars and a location of the diode array from the laser rod are selected to allow the laser rod to receive a substantially uniform illumination of radiation from the high power diode bars and to allow a substantially uniform deposition throughout the interior of a laser rod.

### BACKGROUND

Within the field of optical devices, emphasis towards high power and high brightness lasers has been a continuing goal. Among the more modern types of lasers developed are diode-pumped solid-state (DPSS) lasers. High power DPSS lasers are typically divided into two groups. The first type is a slab configuration, while the second is a rod configuration. Among the rod configurations, two schemes for pumping may be found, transverse and longitudinal pumping. While all types of DPSS lasers have continued to find widespread acceptance, transverse pumped DPSS lasers are perhaps the most commonly employed.

In general, the configuration of transverse-pumped rod DPSS lasers includes a laser rod, comprising a material such as Nd:YAG positioned at the center of the laser assembly. Surrounding the laser rod are multiple diode arrays. The diode arrays can include diode bars formed therein and configured to irradiate the laser rod in order to amplify a low power laser beam. The diode bars are typically about 1 cm wide, and proper design ensures that most of the radiation from the diode bars is absorbed by the laser rod. Alternative designs may also include micro lenses, hollow ducts, or fiber optics to assist in focusing the energy from the diode bars into the laser rod.

Due to the heat generated by the diode bars, coolant, such as cooling water, can be passed over the laser rod to keep it cool. However, even with the use of coolant, the multiple diode arrays must typically be arranged so that the laser rod is uniformly illuminated. Uniform pumping of a laser rod should be performed with two goals in mind. First, the intensity of the light shining on the exterior of the laser rod should be relatively uniform over the entire outer surface of the laser rod. If not, then thermal “hotspots” could develop, thereby leading to undesirable thermal stresses on the laser rod. Second, the intensity of light absorbed throughout the interior of the laser rod should be as close to uniform as possible. By doing this, the laser rod, when properly pumped, will create a spherical lensing effect, which can be readily corrected. As those who are skilled in the relevant field of art understand, both goals can be very difficult to achieve simultaneously. Thus, in order to enable proper compensation with simple spherical lenses, the radiation absorbed throughout the interior of the laser rod should be very uniform. For example, for a Nd:YAG laser rod, uniform energy distribution within the laser rod causes the laser rod to behave as a positive spherical lens. This lensing effect can be readily cancelled by employing a negative spherical lens with the same power as the laser rod.

In DPSS laser assemblies, the cost of the diode arrays surrounding the laser rod is largely driven by the number of diode bars employed in each diode array. Assuming that the number of diode bars in an array stays the same, the cost for low power diode bars versus high power diode bars is usually negligible. It is therefore more cost effective to use fewer high-power diode bars in an array rather than many low-power diode bars. However, conventional DPSS lasers are typically constructed with low-power diode bars, in the range of about 10 to 30 watts, in order to keep the hot spots of the laser rod under control. While employing high power diode bars, with a power level of about 40 watts or greater, in conventional DPSS laser assemblies could improve the cost-effectiveness of the lasers, conventional designs have overheated the laser rod, thereby subjecting it to thermal stresses, possibly leading to fracture. Furthermore, even if fewer diode bars are employed in such conventional assemblies, the location of the diode arrays in relation to the laser rod may cause “hotspots” along the laser rod, resulting in a non-uniform distribution of energy along the exterior of the laser rod. There is therefore a need for a DPSS laser assembly having a diode array capable of employing a smaller number of high-power diode bars that can uniformly irradiate a laser rod.

### BRIEF SUMMARY

Disclosed herein is a diode-pumped solid-state (DPSS) laser comprising a laser rod and a diode array located proximate to the laser rod. In one embodiment, the diode array includes a plurality of high power diode bars spaced along the diode array, where each of the diode bars is configured to emit radiation therefrom. In addition, the spacing of the high power diode bars and the location of the diode array with respect to the laser rod are selected to so that the illumination of the laser rod along its length is substantially uniform. Furthermore, the spacing and location of the diode arrays around the circumference of the laser rod are arranged so that the irradiation provided by the diode arrays is uniformly deposited throughout the interior of the laser rod.

Also disclosed herein is a method of manufacturing a DPSS laser. In one embodiment, the method includes providing a laser rod and locating at least one diode array proximate to the laser rod. The method further includes spacing a plurality of high power diode bars along the diode array, and emitting radiation from each high power diode bar. In addition, the method includes spacing the plurality of high power diode bars and locating the diode array from the laser rod so that illumination of the laser rod along its length is substantially uniform. Furthermore, the spacing and location of the diode arrays around the circumference of the laser rod are arranged so that the radiation provided by the diode arrays is uniformly deposited throughout the interior of the laser rod.

Further disclosed herein is a DPSS laser assembly. In one embodiment, the laser assembly comprises a laser rod and a coolant barrier surrounding the laser rod configured to retain a coolant therebetween. The laser assembly also includes a plurality of diode arrays located proximate to the laser rod. In this embodiment, each of the diode arrays includes a plurality of high-power diode bars spaced thereon and each configured to emit radiation therefrom. Also, the spacing of the high-power diode bars and the location of each of the diode arrays from the laser rod are selected to illuminate the laser rod with radiation that is substantially uniform along the length of the laser rod. Furthermore, the spacing and location of the diode arrays around the circumference of the laser rod are arranged so that the radiation provided by the diode arrays is uniformly deposited throughout the interior of the laser rod.

### BRIEF DESCRIPTION OF THE DRAWINGS

Reference is now made to the following detailed description taken in conjunction with the accompanying drawings. Various features may not be drawn to scale. In fact, the dimensions of various features depicted in the drawings may be arbitrarily increased or reduced for clarity of discussion. In addition, some components may not be illustrated for clarity of discussion. Reference is now made to the following descriptions taken in conjunction with the accompanying drawings, in which:

FIG. 1 illustrates a perspective view of a diode-pumped solid state laser;

FIG. 1A illustrates a longitudinal cross-sectional view of a portion of one embodiment of a diode-pumped solid-state laser;

FIG. 1B illustrates the distribution of illumination intensity of a laser rod by two alternative diode arrays;

FIG. 1D illustrates a longitudinal cross-sectional view of a diode-pumped solid-state laser using relatively high-power diode bars;

FIG. 1E illustrates a longitudinal cross-sectional view of another embodiment of diode-pumped solid state laser system;

FIG. 1F illustrates the differences between uniform energy deposition throughout the interior of a laser rod and non-uniform energy deposition throughout the interior of a laser rod;

FIG. 2 illustrates a transverse cross-sectional view of the portion of a diode-pumped solid-state laser;

FIG. 3 illustrates a transverse cross-sectional view of one embodiment of a diode-pumped solid-state laser system;

FIG. 3A illustrates a transverse cross-sectional view of another embodiment of a diode-pumped solid-state laser system;

FIG. 5 illustrates a longitudinal cross-sectional view of a diode-pumped solid state laser amplifier system; and

FIG. 6 illustrates a longitudinal view of one embodiment of a diode-pumped solid state laser amplifier system.

### DETAILED DESCRIPTION

In the following discussion, numerous specific details are set forth to provide a thorough understanding of the disclosed method and system. However, those skilled in the art will appreciate that the disclosed method and system may be practiced without such specific details. In other instances, well-known elements have been illustrated in schematic or block diagram form in order to describe the embodiments with clarity. Additionally, some details have been omitted inasmuch as these details are not necessary to obtain a complete understanding of the present invention, and are considered to be within the understanding of persons of ordinary skill in the relevant field of art.

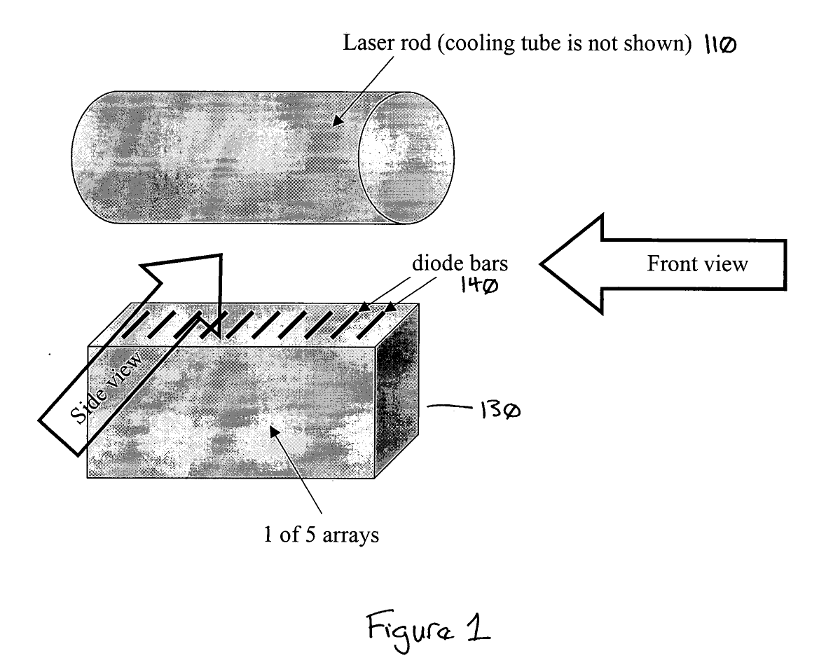

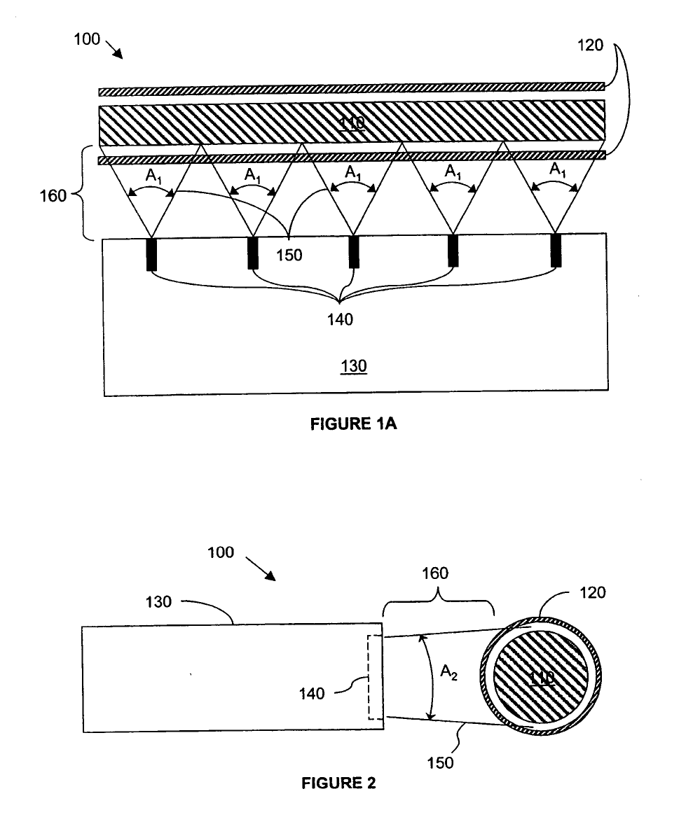

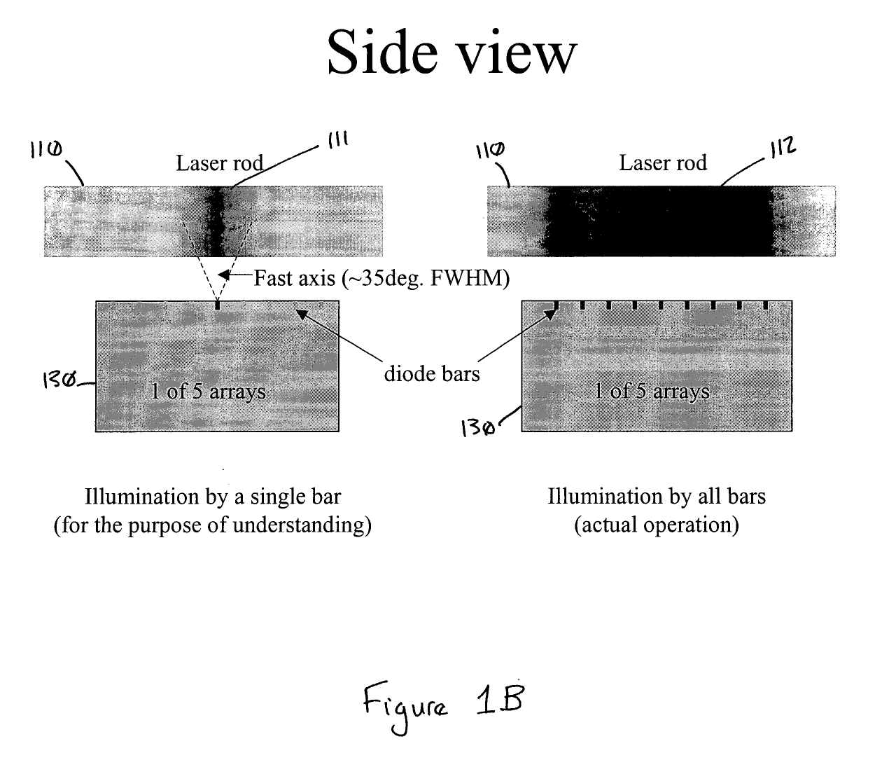

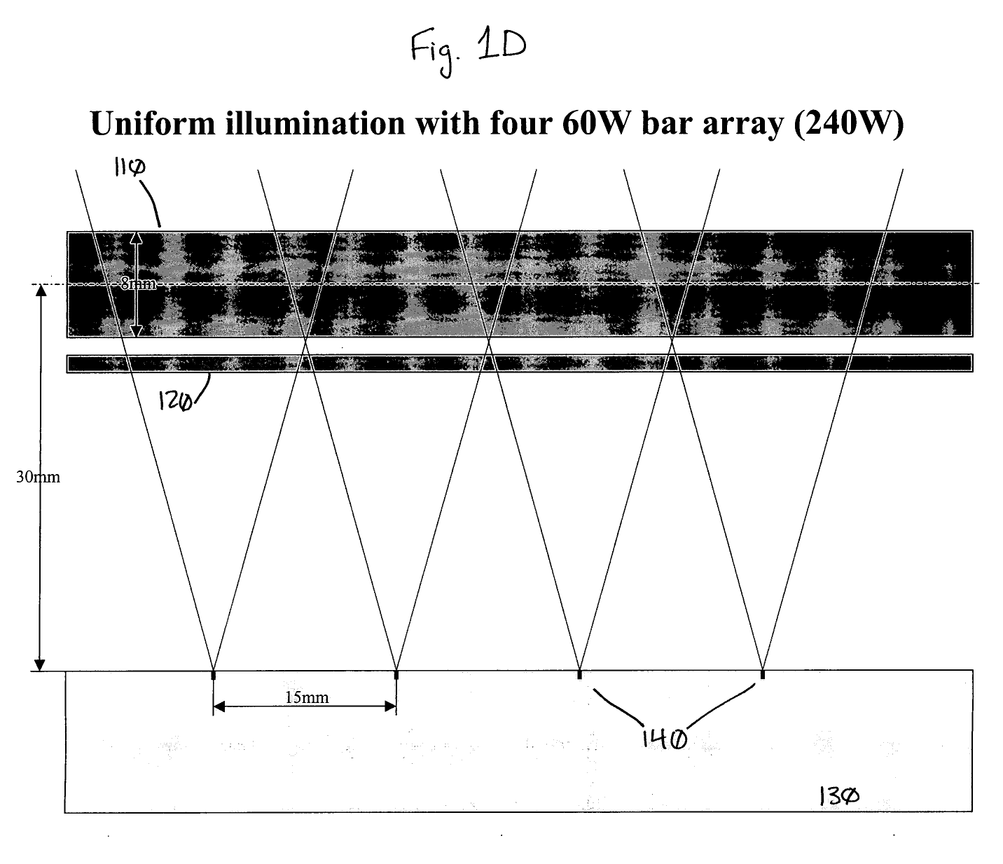

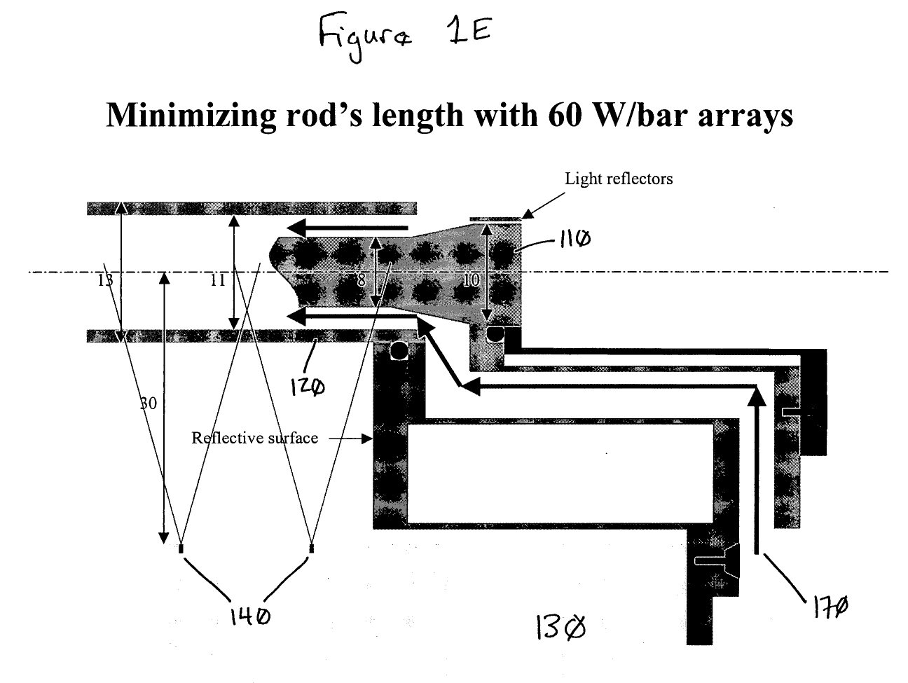

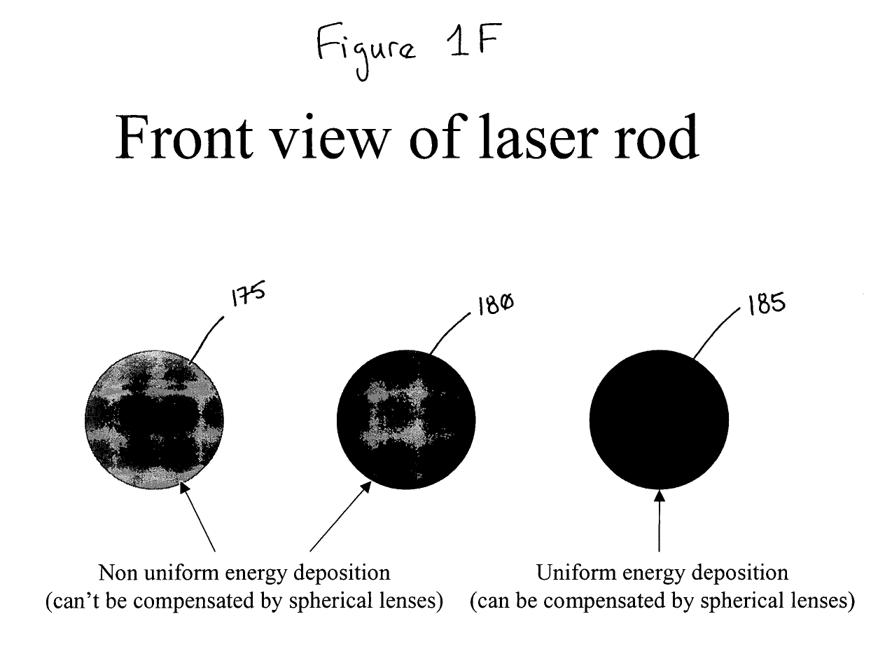

A perspective view of one aspect of the invention is depicted in FIG. 1. In FIG. 1, a laser rod 110 and a laser diode array 130 are depicted as being in close proximity to each other. The laser diode array 130 comprises a series of diode bars 140 that are placed along one side of the array 130. Each of the diode bars emits radiation at a particular wavelength so as to optically pump the laser rod 110. In order to provide an optimal amount of optical pumping, the pitch (i.e., the spacing) of the diode bars and the distance between the laser rod 110 and the diode array 130 can be adjusted so that the laser rod 110 is provided with substantially uniform illumination along its length. This concept is described in further detail below.

With reference to FIG. 1A, a longitudinal cross-sectional view of one embodiment of a diode-pumped solid-state (DPSS) laser 100 is depicted. The DPSS laser 100 includes a laser rod 110 that is constructed of Nd:YAG, but a DPSS laser according to the present invention is not so limited. Surrounding the laser rod 110 is a coolant barrier 120. In the illustrated embodiment, the coolant barrier 120 is a glass tube; however, other types of transparent coolant barriers may also be employed with the DPSS laser 100. Located proximate to the laser rod 110 is a laser diode array 130. A plurality of high-power diode bars 140 are placed in the array 130. As used herein, the term “high power,” when used in reference to diode bars in a diode array, means diode bars manufactured with a power level of about 30 watts or higher. Conversely, “low power” diode bars have a power level of only about 10 to 30 watts. Although only five diode bars 140 are shown in the DPSS laser 100 of FIG. 1, more or less than five high-power diode bars may be employed without deviating from the scope of the invention.

As shown in FIG. 1A, the high-power diode bars 140 are configured to emit a high level of radiation 150. The radiation 150 is transmitted to the laser rod 110 through the transparent coolant barrier 120 to optically pump the laser rod 110. The radiation 150 from each of the high-power diode bars 140 is emitted within a divergence angle A1, corresponding to a fast axis of the diode bars 140. In the illustrated embodiment, the divergence angle A1 of the radiation 150 is about 35 to 40 degrees. In addition, the diode bars 140 have a spacing, or “pitch,” between each other that helps determine the point at which the radiation 150 emitted from a diode bar 140 overlaps the radiation emitted from an adjacent diode bar 140. Preferably, the pitch of the diode bars 140 is selected such that the full-width, half-max (FWHM) point of the radiation beam 150 from one diode bar 150 overlaps the FWHM point of an adjacent radiation beam 150 at the surface of the laser rod 110. In this manner, the distribution of radiation shining on the surface of the laser rod 110 will be substantially uniform along the length of the laser rod 110. Although the pitch of the diode bars 140 can be used to adjust the place at which the FWHM points overlap, the distance 160 between the diode array 130 and the laser rod 110 can also affect the intensity of the radiation illuminating the laser rod 110.

Once the divergence angle A1 of the radiation 150 is determined, and the pitch between each of the high power diode bars 140 is selected, a distance 160 between the diode array 130 and the laser rod 110 must also be established in order to ensure that the FWHM points of adjacent diode bars 140 properly overlap. In accordance with the principles disclosed herein, the distance 160 is selected, in combination with the pitch of the diode bars 140 in the diode array 130 and the divergence angle A1 of the radiation 150 emitted therefrom, such that the laser rod 110 receives substantially uniform illumination along its length. As used herein, the term “substantially uniform illumination” means a fluctuation in the level of radiation reaching the irradiated surface of the laser rod 110 along a longitudinal section of about 10% or less. As a result, a radiation distribution of about 30% or greater is not substantially uniform, while a fluctuation in the range of about 10% to 30% would be marginal, but acceptable. Thus, as discussed above, a substantially uniform illumination along the length of the laser rod 110 is achieved when the radiation 150 from the high power diode bars 140 overlap each other at the FWHM point on the laser rod 110, with no overlap or spacing between adjacent emissions of radiation 150. A lesser or greater distance 160 would likely result in an uneven distribution of radiation 150 across the laser rod 110, which typically results in “hotspots” (areas of significantly greater levels of radiation) along the length of the laser rod 110. Such hotspots may result in undesirable thermal stresses if permitted to occur during operation.

The effects of overlapping the FWHM points of each of adjacent diode bars 140 on the surface of the laser rod 110 is further depicted in FIG. 1B. In FIG. 1B, the amount of illumination provided by a single diode bar 111 and a series of adjacent diode bars 112 are depicted. By optimally aligning the pitch of the diode bars 140 and the distance of the diode array 130 from the laser rod 110, the laser rod 110 may be illuminated with substantially uniform radiation 112.

According to one embodiment, the diode array 130 includes five diode bars 140, each having a power level of about 50 watts and a divergence angle A1 of about 40 degrees. In this example, the pitch of the diode bars 140 is about 12.5 mm, the overall length of the diode array 130 is about 100 mm, and the width of the diode array is about 19 mm. With these parameters, the distance 160 between the diode array 130 and the laser rod 110 will be increased beyond the distance found in conventional DPSS lasers. Specifically, using these parameters, the distance 160 between the diode array 130 and the center of the laser rod 110 should be about 25 mm in order for the laser rod 110 to receive substantially uniform illumination along its length. Of course, in other embodiments, the pitch of the diode bars 140, and the distance 160 between the diode array 130 and the laser rod 110 can be adjusted to other values so that the laser rod 110 receives substantially uniform illumination along its length.

An embodiment of one aspect of the invention utilizing high-power diode bars 140 is depicted in FIG. 1D. In FIG. 1D, only four diode bars 140 are utilized in the diode array 130. Each of these diode bars 140 is rated at 60 watts of nominal power. Accordingly, four of these diode bars 140 are able to provide the same amount of power as would twelve 20-watt bars. Although fewer diode bars 140 are utilized in this embodiment, the spacing between the diode array 130 and the laser rod 110 must be increased in order to ensure that the FWHM points corresponding to each diode bar overlap on the surface of the laser rod 110. By doing this, the laser rod 110 will be illuminated with a substantially uniform amount of radiation along its length without causing undesirable thermal stresses.

From the above, it may be seen that the relationship between the pitch of the diode bars in a diode array, the FWHM divergence angle of the radiation emitted from the diode bars, and the distance of the diode array from the irradiated laser rod are important factors in the design of DPSS laser system. In addition, a significant reduction in overall manufacturing costs associated with employing high-power diode bars rather than low-power diode bars is an important factor to consider. Those who are skilled in the relevant technology field understand that conventional DPSS lasers typically employ a large number of low-power diode bars in each laser array. Low-power diode bars are often used because a decrease in the overall size of the laser assembly may be desired. In order to decrease the overall size, the diode arrays employed in conventional assemblies are positioned close to the laser rods. Furthermore, by positioning the diode arrays close to the laser rod 110, more of the light emitted along the slow axis will be captured by the laser rod 110. However, moving the diode arrays closer also requires the use of low-power diode bars so as not to cause hotspots along the laser rod or other thermal stresses that may result in rod fracture. In order to maintain a uniform level of illumination along the length of the laser rod, a greater number of such low power diode bars are used.

As discussed above, the cost of a DPSS laser significantly increases as the number of diode bars employed increases. Conversely, the overall cost of a high-power diode bar is not significantly more than the cost of a low-power diode bar. As a result, a DPSS laser constructed with diode arrays comprising fewer high-power diode bars enjoys a significant savings in overall manufacturing costs by employing a far fewer number of diode bars. Additionally, the diode arrays housing the high-power diode bars are relocated further away from the laser rod to adjust for the higher power level of the diode bars, and for the greater spacing present between diode bars when fewer are employed. The result of optimizing the relationship between these parameters is a higher efficiency DPSS laser assembly with a significantly reduced cost of manufacturing. Although more cost-efficient, a DPSS laser assembly according to the principles disclosed herein is counter-intuitive to the conventional approach of placing a larger number of low-power diode bars closer to a laser rod.

A cross-sectional view of one embodiment of the invention is depicted in FIG. 1E. In FIG. 1E, a portion of a diode array 130 is depicted as comprising two diode bars 140. Also depicted is a laser rod 110 that receives the illumination provided by the diode array with substantially uniform illumination along its length. Specifically, it can be seen that the FWHM point of each adjacent diode bar 140 overlaps at the surface of the laser rod 110. Also depicted in FIG. 1E is a coolant 170 that is provided between the laser rod 110 and the coolant barrier 120. Preferably, this coolant 170 is translucent so that the illumination from the diode array 130 can pass directly into the laser rod 110.

The concept of uniform energy deposition throughout the interior of a laser rod is depicted in FIG. 1F. In FIG. 1F, a cross-sectional view of three laser rods being illuminated with radiation are depicted. Laser rods 175 and 180 are receiving non-uniform energy deposition. More specifically, the amount of energy deposited in laser rod 175 is concentrated at its center. On the other hand, the energy deposited in laser rod 180 is concentrated around its circumference. In situations in which the energy is not uniformly deposited throughout the interior of the laser rod, a non-spherical lensing effect is created, which can be difficult to correct. However, if the energy deposited in the interior of the laser rod 110 is uniform throughout the interior of the laser rod, this creates a spherical lensing effect. This spherical lensing effect can be readily compensated or corrected with optical components.

Turning now to FIG. 2, a transverse cross-sectional view of the portion of a DPSS laser 100 is illustrated. As may be seen in FIG. 2, the angle of divergence A2 of the radiation 150 from the diode bars 140 along the “slow axis” is far smaller than the divergence angle A1 along the “fast axis,” which is depicted FIG. 1. In the illustrated embodiment, the slow divergence angle A2 is only about 6 to 8 degrees. As a result, the distance 160 between the diode array 130 and the laser rod 110 may be increased without a significant loss of the radiation 150 illuminating the laser rod 110. Of course, a DPSS laser according the principles disclosed herein is not limited to any particular slow divergence angle A2, so long as the distance 160 between the laser rod 110 and the diode array 130 is selected without a significant loss in radiation illuminating the laser rod 110.

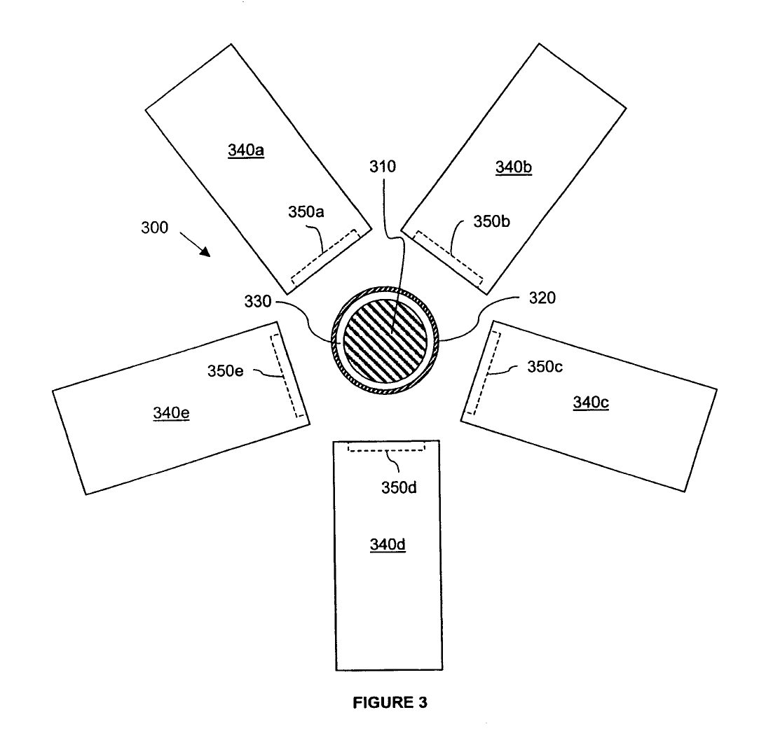

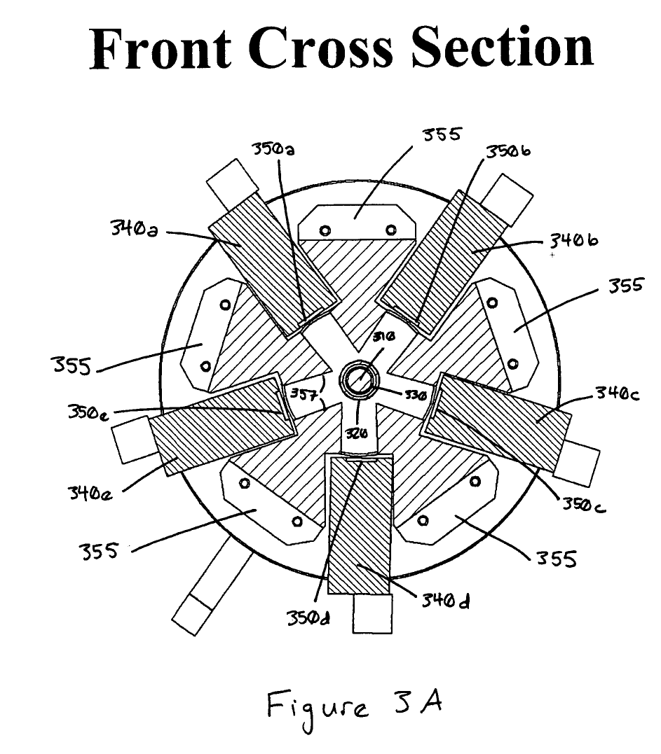

Referring now to FIG. 3, another transverse cross-sectional view of one embodiment of a DPSS laser assembly 300 is illustrated. Similar to the DPSS laser 100 in FIG. 1, the DPSS laser assembly depicted in FIG. 3 includes a laser rod 310 surrounded by a coolant barrier 320. Interposed between the laser rod 310 and the insulation barrier 320 is a coolant 330. In an exemplary embodiment, the insulation barrier 320 is a transparent glass tube extending the approximate length of the laser rod 310. In a more specific embodiment, the coolant is water that is pumped between the laser rod 310 and the insulation barrier 320. Other appropriate coolants may also be employed.

The DPSS laser assembly illustrated in FIG. 3 includes five diode arrays 340a-340e. Of course, any number of diode arrays may be employed without deviating from the scope of the invention, so long as the arrays are arranged to provide substantially uniform energy deposition throughout the interior of the laser rod 310. It is preferable that an odd number of diode arrays be implemented to avoid directly illuminating a diode array on another side of the laser rod 310. Also shown in the DPSS laser assembly 300 are high power diode bars 350a-350e corresponding to each diode array 340a-340e. As before, the diode bars 350a-350e in each diode array 340a-340e are arranged along the length of the diode array to provide substantially uniform illumination of the laser rod 310 along its length. In addition, the multiple diode arrays 340a-340e are arranged in a uniform and symmetrical manner around the laser rod 310. By arranging the multiple diode arrays 340a-340e in such a manner, the diode bars 350a-350e may provide the laser rod 310 with substantially uniform illumination around the outer circumference of the laser rod 310. As discussed in greater detail above, the spacing of the diode arrays 340a-340e from the laser rod 310 is also carefully selected so as to maintain the substantially uniform illumination on the longitudinal surface of the laser rod and to insure substantially uniform absorption of the radiation throughout the interior of the laser rod.

A cross-sectional view of an alternative embodiment of one aspect to the invention is depicted in FIG. 3A. In FIG. 3A, a laser rod 310 is surrounded by a coolant 330 and an coolant barrier 320. Also depicted are five diode arrays 340a-340e, each of which comprises at least one diode bar 350a-350e. Each of the diode arrays 340a-340e is securely mounted in this arrangement by a plurality of mounting devices 355. Each of these mounting devices 355 maintains a pre-determined distance between the diode arrays 340a-340e and the laser rod 310 so that the outer surface of the laser rod 310 receives a substantially uniform illumination. An inner portion of the mounting devices 357 comprises a reflective surface that is used to increase the amount of light received by the laser rod 310.

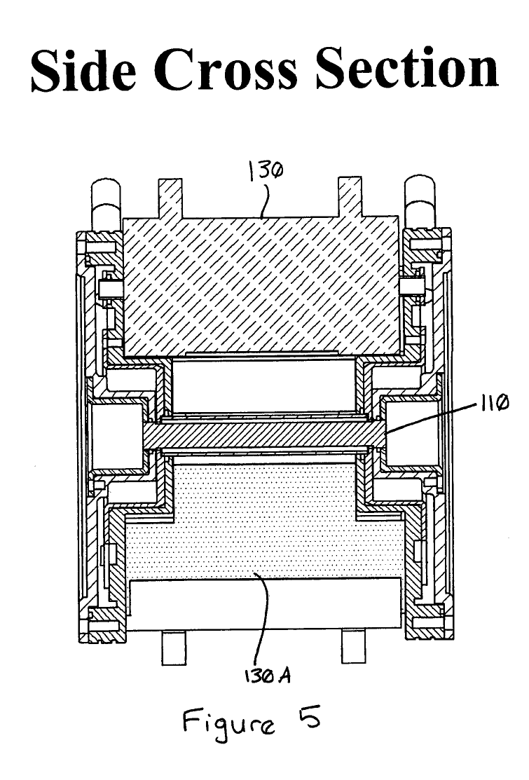

A longitudinal cross-sectional view of another aspect of the invention is depicted in FIG. 5. In FIG. 5, a diode array 130 and the laser rod 110 are depicted in cross-section along with the associated equipment required to maintain the alignment of these components. Because the embodiment depicted in FIG. 5 utilizes an odd number of diode arrays around the laser rod 110, a side view, rather than a cross-sectional view, of a diode array 130A is also depicted. Although it appears that the diode array 130A is disposed closer to the laser rod 110, this is an artifact of the perspective view of FIG. 5 in which diode array 130A is aligned with the laser rod 110 at an angle. FIG. 5 also depicts the distance between diode array 130 and the laser rod 110 whereby the longitudinal surface of the laser rod 110 receives a substantially uniform illumination along its length.

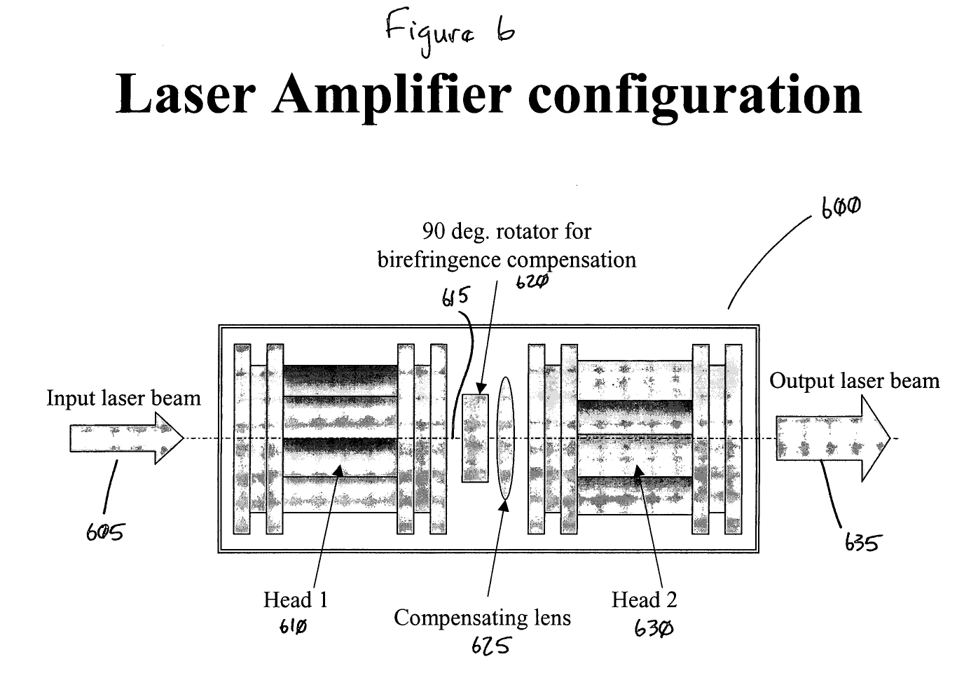

Another embodiment of a laser amplifier system 600 utilizing the disclosed methods and apparatuses is depicted in FIG. 6. In FIG. 6, an input laser beam 605 is provided to the system where it is processed by a first amplifying head 610. The first amplifying head 610 comprises a laser rod 110 surrounded by a plurality of diode arrays 130 so as to form a laser amplification system. Utilizing the techniques and methods described previously, the input laser beam 605 is amplified by the first amplifying head 610 to form an intermediate laser beam 615. The laser amplifying head 610 will impart certain birefringence to the input laser beam, which is required to be corrected. Accordingly, a 90-degree rotator 620 is utilized. The 90-degree rotator 620 receives the intermediate laser beam 615 and rotates its polarization by 90 degrees. After this, the intermediate laser beam 615 is received by a compensating lens 625, which corrects the spherical lensing effects produced by the first amplifying head 610. As stated previously, an optimally configured amplifying head will act as a spherical lens as it amplifies incoming light. According to one embodiment, the first amplifying head 610 comprises a Nd:YAG laser rod which therefore produces a positive spherical lensing effect. Accordingly, a negative spherical compensating lens 625 is utilized to cancel this effect. After passing through the compensating lens 625, the intermediate laser beam 615 is passed into a second amplifying head 630. The second amplifying head 630 comprises a laser rod 110 surrounded by a plurality of diode arrays 130. According to one embodiment, however, the diode arrays 130 are disposed at angles inversely-proportional to the angles of the diode arrays in the first amplifying head 610. For example, if the diode arrays 130 of the first amplifying head 610 are disposed at angles of 0, 72, 144, 216 and 288 degrees, then the diode arrays of the second amplifying head 630 will be disposed at angles of 36, 108, 180, 252 and 324 degrees. As a result, the input laser beam will be amplified by an apparent set of ten diode arrays, each of which is spaced 36 degrees apart. After passing through the second amplifying head 620, an amplified, compensated and corrected output laser beam 635 is provided.

Although the present invention has been described in detail, those skilled in the art should understand that various changes, substitutions and alterations can be made without departing from the spirit and scope of the invention in its broadest form. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. The Applicants intend that the claims shall not involve the application of 35 U.S.C § 112, ¶ 6 unless the claim is explicitly written in means-plus-function or step-plus-function format.

The following is claimed:

1. A diode-pumped solid state laser amplifier, comprising:
a laser rod; and
at least one diode array located proximate to the laser rod, each diode array having a plurality of high-power diode bars spaced thereon wherein the spacing of the high-power diode bars and the location of the diode array from the laser rod are selected to allow the laser rod to receive the radiation emitted by the diode bars in a substantially uniform distribution along the length of the laser rod.

2. A laser amplifier as recited in claim 1, wherein each of the high-power diode bars produces at least about 50 W.

3. A laser amplifier as recited in claim 1, wherein each diode array includes five high-power diode bars.

4. A laser amplifier as recited in claim 3, wherein the plurality of high-power diode bars have a spacing of about 12.5 mm in the diode array.

5. A laser amplifier as recited in claim 4, wherein the distance from each diode array to the center of the laser rod is about 25 mm.

6. A laser amplifier as recited in claim 1, wherein five diode arrays are placed around the circumference of the laser rod with an angular separation of about 72 degrees.

7. A laser amplifier as recited in claim 1, further comprising a transparent coolant barrier surrounding the laser rod, wherein the coolant barrier is operable to pass a coolant over the surface of the laser rod.

8. A laser amplifier as recited in claim 7, wherein the coolant comprises water.

9. A diode-pumped solid state laser amplifier comprising:
a first laser rod having a longitudinal axis;
an odd number of first diode arrays located proximate to the first laser rod, each first diode array having a plurality of high-power diode bars spaced thereon wherein the spacing of the high-power diode bars and the location of the first diode array from the first laser rod are selected to allow the first laser rod to receive radiation emitted by the diode bars in a substantially uniform distribution along the length of the first laser rod, wherein the first diode arrays are positioned around the circumference of the laser rod with an even angular separation;
a second laser rod having a longitudinal axis that is aligned with the longitudinal of the first laser rod;
an odd number of second diode arrays located proximate to the second laser rod, each second diode array having a plurality of high-power diode bars spaced thereon wherein the spacing of the high-power diode bars and the location of the second diode array from the second laser rod are selected to allow the second laser rod to receive radiation emitted by the diode bars in a substantially uniform distribution along the length of the second laser rod, wherein the second diode arrays are positioned around the circumference of the laser rod with an even angular separation that is inversely proportional to the angular separation of the first diode arrays;
a 90 degree rotator disposed between the first and second laser rods along the longitudinal axes of the laser rods; and
a compensating lens disposed between the first and second laser rods along the longitudinal axes of the laser rods, wherein the compensating lens imparts a negative spherical lensing effect.

10. A laser amplifier as recited in claim 9, wherein each of the high-power diode bars produces at least about 50 W.

11. A laser amplifier as recited in claim 9, wherein each of the first and second diode arrays includes five high-power diode bars.

12. A laser amplifier as recited in claim 11, wherein the plurality of high-power diode bars have a spacing of about 12.5 mm in the respective diode array.

13. A laser amplifier as recited in claim 12, wherein the distance from each diode array to the center of the respective laser rod is about 25 mm.

14. A laser amplifier as recited in claim 9, wherein five diode arrays are placed around the circumference of the first laser rod with an angular separation of about 72 degrees and five diode arrays are placed around the circumference of the second laser rod with an angular separation of about 72 degrees.

15. A laser amplifier as recited in claim 9, further comprising a transparent coolant barrier surrounding the laser rod, wherein the coolant barrier is operable to pass a coolant over the surface of the laser rod.

16. A laser amplifier as recited in claim 9, wherein the coolant comprises water.

17. A method of manufacturing a diode-pumped solid state laser amplifier, comprising:
providing a laser rod; and
locating at least one diode array proximate to the laser rod, each diode array including a plurality of high-power diode bars, wherein spacing of the high-power diode bars and the location of the diode array from the laser rod allows the laser rod to receive radiation from the diode arrays in a substantially uniform distribution along the length of the laser rod.
